(19) United States
(12) Patent Application Publication
(10) Pub. No.: US 2026/0223883 A1
(43) Pub. Date: Aug. 6, 2026

(54) FROZEN DESSERT PRODUCT AND METHOD FOR PRODUCING THE SAME

(71) Applicant: LOTTE CO., LTD., Tokyo (JP)

(72) Inventors: Hiroyuki TAKAMATSU, Saitama (JP); Shoko ANDO, Saitama (JP); Akihiro OZEKI, Saitama (JP); Shouko YANAI, Saitama (JP); Mami YAMAMOTO, Saitama (JP)

(73) Assignee: LOTTE CO., LTD., Tokyo (JP)

(21) Appl. No.: 19/133,621

(22) PCT Filed: Nov. 6, 2023
(86) PCT No.: PCT/JP2023/039896

§ 371 Date: May 28, 2025

(30) Foreign Application Priority Data
Dec. 2, 2022 (JP) 2022-193266

(51) Int. Cl. A23G 9/32; A23G 9/34; A23G 9/38; A23G 9/40

(52) U.S. Cl. CPC A23G 9/327; A23G 9/34; A23G 9/38; A23G 9/40; A23G 2200/06; A23G 2200/08; A23G 2200/10; A23G 2200/12

(57) ABSTRACT

A frozen dessert product including a raw material cacao containing cocoa butter, a sucrose fatty acid ester, and casein or a salt thereof.

### TECHNICAL FIELD

The present invention relates to a frozen dessert product and a method for producing the same.

### BACKGROUND ART

In accordance with the “Fair Competition Code and Enforcement Rules of Fair Competition Code on Labeling of Ice Creams and Frozen Sweets”, chocolate ice cream is required to “contain 1.5% by weight or more of cacao”. Currently, cocoa powder is mainly used to satisfy this requirement, and chocolate ice cream containing many chocolate bases is not widely distributed.

A large amount of cocoa butter is blended (e.g. 3% by mass or more), as a result of which, in a production step of a frozen dessert product (particularly, an aging step of keeping the frozen dessert mix at a low temperature for a long period of time, the viscosity of the frozen dessert product increases over time, which may cause a problem in handleability.

To suppress such thickening of the frozen dessert product, for example, Patent Literature 1 discloses “a frozen dessert product including cocoa butter, phosphate, a sucrose fatty acid ester, and a sorbitan fatty acid ester, in which the phosphate is metaphosphate or polyphosphate”.

In addition, Patent Literature 2 discloses “a frozen dessert product containing cacao fat, in which the frozen dessert product contains a sucrose fatty acid ester, the sucrose fatty acid ester satisfying the following requirements (1) to (3): (1) the sucrose fatty acid ester has an HLB of 5 or more; (2) a constituent fatty acid in the sucrose fatty acid ester is comprised of 70% or more of a saturated fatty acid; and (3) the sucrose fatty acid ester contains 30% or more of monoester”.

Further, Patent Literature 3 discloses “a low-viscous high-fat ice cream mix containing 0.5% to 2.0% by weight of casein sodium and a chocolate ice cream mix”.

### CITATION LIST

### Patent Literature

Patent Literature 1: JP 2008-301814 A
Patent Literature 2: JP 5225912 B2
Patent Literature 3: JP S63-287446 A

### SUMMARY OF INVENTION

### Technical Problem

The present invention provides a component for suppressing thickening of a frozen dessert product containing a raw material cacao (particularly, a frozen dessert product containing cocoa butter), and a frozen dessert product containing the component.

### Solution to Problem

The present inventors have extensively conducted studies, and resultantly found that use of a sucrose fatty acid ester in combination with casein or a salt thereof makes it possible to suppress thickening of a frozen dessert product containing a raw material cacao (particularly a frozen dessert product containing cocoa butter).

Patent Literatures 1 to 3 do not disclose that a sucrose fatty acid ester is used in combination with casein or a salt thereof.

The present invention includes the following embodiments.

[1]

A frozen dessert product including:
a raw material cacao containing cocoa butter;
a sucrose fatty acid ester; and
casein or a salt thereof.
   [2]

The frozen dessert product according to [1], wherein an amount of the casein or a salt thereof is from 50 to 84% by mass based on a total mass of the sucrose fatty acid ester and the casein or a salt thereof.

[3]

The frozen dessert product according to [1] or [2], wherein a total amount of the sucrose fatty acid ester and the casein or a salt thereof is 0.64% by mass or more based on the mass of the frozen dessert product.

[4]

The frozen dessert product according to any one of to [3], wherein an amount of the cocoa butter is from 3 to 22% by mass based on the mass of the frozen dessert product.

[5]

The frozen dessert product according to any one of [1] to [4], wherein the sucrose fatty acid ester has a hydrophilic-lipophilic balance of 1 to 15.

[6]

A method for producing a frozen dessert product, including mixing
a raw material cacao containing cocoa butter,
a sucrose fatty acid ester, and
casein or a salt thereof.
   [7]

The method according to [6], wherein an amount of the casein or a salt thereof is from 50 to 84% by mass based on a total mass of the sucrose fatty acid ester and the casein or a salt thereof.

[8]

The method according to [6] or [7], wherein a total amount of the sucrose fatty acid ester and the casein or a salt thereof is 0.64% by mass or more based on the mass of the frozen dessert product.

[9]

The method according to any one of [6] to [8], wherein an amount of the cocoa butter is from 3 to 22% by mass based on the mass of the frozen dessert product.

[10]

The method according to any one of [6] to [9], wherein the sucrose fatty acid ester has a hydrophilic-lipophilic balance of 1 to 15.

### Advantageous Effects of Invention

According to the present invention, it is possible to provide a component for suppressing thickening of a frozen dessert product containing a raw material cacao (particularly, a frozen dessert product containing cocoa butter), and a frozen dessert product containing the component.

### BRIEF DESCRIPTION OF DRAWINGS

FIG. 1 shows temporal changes in viscosity of various frozen dessert products in which the amount of cocoa butter is changed.

FIG. 2 shows temporal changes in viscosity of various frozen dessert products in which components of an emulsifier are changed.

FIG. 3 shows a relationship between a proportion of casein sodium and the viscosity of each of the frozen dessert products.

FIG. 4 shows a relationship between a total amount of an emulsifier and the viscosity of each of the frozen dessert products.

FIG. 5-1 shows temporal changes in viscosity of various frozen dessert products in which components of an emulsifier are changed.

FIG. 5-2 shows temporal changes in viscosity of various frozen dessert products in which components of an emulsifier are changed.

FIG. 6 shows temporal changes in viscosity of various frozen dessert products in which components of an emulsifier are changed.

FIG. 7 shows temporal changes in viscosity of various frozen dessert products in which an HLB of a sucrose fatty acid ester is changed.

### DESCRIPTION OF EMBODIMENTS

Hereinafter, embodiments of the present invention will be specifically described, but the present invention is not limited to these embodiments, and can be modified in various ways without departing from the gist thereof.

### <Frozen Dessert Product>

One embodiment of the present invention relates to a frozen dessert product including: a raw material cacao containing cocoa butter; a sucrose fatty acid ester; and casein or a salt thereof.

The frozen dessert product according to this embodiment contains a combination of a sucrose fatty acid ester and casein or a salt thereof although it contains cocoa butter, thereby making it possible to suppress thickening of the frozen dessert product in the production process. Preferably, the frozen dessert product according to this embodiment contains a combination of a sucrose fatty acid ester and casein or a salt thereof, as a result of which it has a good melting in the mouth texture and excellent chocolate flavor.

The term “frozen dessert product” used herein refers to a sweet product stored under refrigerated conditions, such as ice creams and frozen sweets, and does not include a sweet product stored in a chilled temperature zone, such as pudding.

The ice creams encompass ice cream, ice milk, and lacto-ice. The terms “ice creams”, “ice cream”, “ice milk”, and “lacto-ice” used herein are specified in “Ministerial Ordinance on Milk and Milk products Concerning Compositional Standards, etc.” (Ministry of Health and Welfare Ordinance No. 106, Aug. 8, 2018).

Specifically, ice creams mean the products which are obtained by freezing material made by processing milk or food manufactured from milk, or material made from these principal ingredients, provided the product contains 3.0% or more of milk solids (excluding fermented milk).

Ice cream has a milk solids content of 15.0% or more and a milk fat content of 8.0% or more.

Ice milk has a milk solids content of 10.0% or more and a milk fat content of 3.0% or more (excluding ice cream).

Lacto-ice has a milk solids content of 3.0% or more (excluding ice cream and ice milk).

The frozen sweets mean the products obtained by freezing a sugar solution or a liquid prepared by mixing another food with the sugar solution, or a product obtained by crushing edible ice, mixing a sugar solution or another food with the crushed ice, and re-freezing the mixture, and the product is provided in a frozen state.

### [Sucrose Fatty Acid Ester]

The frozen dessert product according to this embodiment contains a sucrose fatty acid ester. The use of the sucrose fatty acid ester in combination with casein or a salt thereof to be described later makes it possible to suppress thickening of the frozen dessert product in the production process.

The term “sucrose fatty acid ester” used herein means a compound in which sucrose is esterified to a fatty acid.

Examples of the fatty acid in the sucrose fatty acid ester include fatty acids having 4 to 30 carbons, 6 to 28 carbons, 8 to 26 carbons, 10 to 24 carbons, 12 to 22 carbons, 14 to 20 carbons, or 16 to 18 carbons. The fatty acid may be a saturated fatty acid or an unsaturated fatty acid.

The hydrophilic-lipophilic balance (HLB) of the sucrose fatty acid ester is not particularly limited, but is preferably from 1 to 15, more preferably from 8 to 13, and still more preferably from 11 to 13. The use of the sucrose fatty acid ester having an HLB in the above range makes it possible to further improve the thickening suppression effect. The HLB can be adjusted, for example, by changing the type and amount of fatty acid that binds to sucrose.

The HLB can be determined by a Griffin method. Specifically, the HLB can be determined in accordance with the following formula:

$$HLB value = 20 \times ( {M}_{H} / M )$$

M_{H}: molecular weight of hydrophilic group of sucrose fatty acid ester
M: overall molecular weight of sucrose fatty acid ester

The amount of the sucrose fatty acid ester is preferably from 0.1 to 2.0% by mass, more preferably from 0.1 to 1.0% by mass, and still more preferably from 0.2 to 0.6% by mass, based on the mass of the frozen dessert product. The use of the sucrose fatty acid ester in the above amount makes it possible to further improve the thickening suppression effect.

### [Casein or Salt Thereof]

The frozen dessert product according to this embodiment contains casein or a salt thereof. The use of casein or a salt thereof in combination with the sucrose fatty acid ester described above makes it possible to suppress thickening of the frozen dessert product in the production process.

Examples of the salt of casein include casein sodium, potassium caseinate, calcium caseinate, and magnesium caseinate.

The amount of casein or a salt thereof is preferably from 0.3 to 7.0% by mass, more preferably from 0.3 to 1.7% by mass, and still more preferably from 0.6 to 1.0% by mass, based on the mass of the frozen dessert product. The use of the casein or a salt thereof in the above amount makes it possible to further improve the thickening suppression effect.

The total amount of the sucrose fatty acid ester and casein or a salt thereof is preferably from 0.54 to 9.0% by mass, more preferably from 0.6 to 2.0% by mass, and still more preferably from 0.64 to 1.2% by mass based on the mass of the frozen dessert product. The use of the sucrose fatty acid ester and casein or a salt thereof in the above amounts makes it possible to further improve the thickening suppression effect.

The amount of casein or a salt thereof is preferably from 50 to 84% by mass, more preferably from 55 to 80% by mass, and still more preferably from 60 to 75% by mass, based on the total mass of the sucrose fatty acid ester and casein or a salt thereof. The use of the casein or a salt thereof in the above amount makes it possible to further improve the thickening suppression effect.

### [Cocoa Butter]

The frozen dessert product according to this embodiment contains a raw material cacao containing cocoa butter. The use of the raw material cacao containing cocoa butter makes it possible to impart a rich chocolate flavor to the frozen dessert product.

Examples of the raw material cacao include cacao mass, cacao beans, cocoa butter, cocoa cakes, and cocoa powders.

The definition of “cocoa butter” used herein is in accordance with “Fair Competition Code on Labeling of Chocolate” (partially modified on Dec. 10, 2021) (hereinafter referred to as “Chocolate Regulations”). Specifically, the term “cocoa butter” means fat obtained from cacao beans, cacao nib or cacao mass, and does not include fat of shell or germ in an amount equal to or more than the amount that is naturally contained. Note that the definition of terms described in the definition of cocoa butter is also in accordance with the Chocolate Regulations (the same applies to the cacao mass, cacao beans, cocoa cakes, cocoa powder, chocolate base, and cacao content described above or below).

Cocoa butter may be contained in the frozen dessert product as such or as a chocolate base containing cocoa butter.

The amount of cocoa butter is preferably from 3 to 22% by mass, more preferably from 5 to 20% by mass, and still more preferably from 10 to 18% by mass, based on the mass of the frozen dessert product. The use of the cocoa butter in the above amount makes it possible to improve the chocolate flavor and suppress thickening of the frozen dessert product.

### [Cacao Content]

The cacao content of the frozen dessert product according to this embodiment is preferably 0.6% by mass or more, more preferably 1.5% by mass or more, based on the mass of the frozen dessert product. Since the cacao content is as described above, the “name of chocolate or chocolate” can be used for the frozen dessert product in accordance with the “Fair Competition Code and Enforcement Rules of Fair Competition Code on Labeling of Ice Creams and Frozen Sweets”. The upper limit of the cacao content is not particularly limited, but may be, for example, 40% by mass, 30% by mass, or 20% by mass based on the mass of the frozen dessert product.

The term “cacao content” used herein means the total amount of cacao nib, cacao mass, cocoa butter, cocoa cake, and cocoa powder (cacao products excluding a fragrance and other components) from which water is removed.

### [Additional Component]

The frozen dessert product according to this embodiment may further contain an additional component. Examples of the additional component include carbohydrates (saccharides and polysaccharides), fruit juice, fats and oils, dairy products, emulsifiers, stabilizers, fragrances, coloring agents, acidulants, pH adjusters, water, eggs, and salts.

The frozen dessert product according to this embodiment may or need not further contain phosphate (specifically, metaphosphate and/or polyphosphate).

The frozen dessert product according to this embodiment may or need not further contain a sorbitan fatty acid ester.

The frozen dessert product according to this embodiment may or need not further contain mono-glyceride of fatty acid.

### <Method for Producing Frozen Dessert Product>

One embodiment of the present invention relates to a method for producing a frozen dessert product, including mixing a raw material cacao containing cocoa butter, a sucrose fatty acid ester, and casein or a salt thereof.

In the production method according to this embodiment, despite the fact that the frozen dessert product contains cocoa butter, the use of a combination of a sucrose fatty acid ester and casein or a salt thereof makes it possible to suppress thickening of the frozen dessert product in the production process. Therefore, this embodiment can also be expressed as a method for suppressing thickening of a frozen dessert product, the method including mixing a raw material cacao containing cocoa butter, a sucrose fatty acid ester, and casein or a salt thereof.

The details of the components of the frozen dessert product in this embodiment are as described in the section of <Frozen Dessert Product>.

Examples of the production step of a frozen dessert product include mixing of ingredients, filtration, homogenization, sterilization, aging, and freezing. The production method or the thickening suppression method according to this embodiment also preferably includes these steps.

### EXAMPLES

Hereinafter, the present invention will be described in more detail with reference to Examples and Comparative Examples, but the technical scope of the present invention is not limited thereto. Unless otherwise specified, “%” means “% by mass”.

The viscosity of each of the frozen dessert products of Examples and Comparative Examples described later was measured according to the following measurement method and measurement conditions. The frozen dessert products were kept at 5° C. for the measurement of the viscosity over time.

### (Measurement Method)

1. A measurement liquid: frozen dessert mix was prepared in a 200 ml (inner diameter: 67 mm) beaker.
2. The temperature of the measurement liquid was adjusted to 10° C.
3. A guard rotor was attached to a viscometer.
4. The inside of the temperature-controlled beaker was stirred 20 times, and then the viscosity was measured.

### (Measurement Conditions)

Apparatus: TVB-10 viscometer (manufactured by Toki Sangyo Co., Ltd.)
Rotor: No. 21 (M2) or No. 22 (M3)
Rotation speed: 30 rpm
Time: 30 seconds

Preferably, the viscosity of each of the frozen dessert products two days later (48 hours later) is 3000 mPa-s or less. In a case where the viscosity exceeds the above viscosity, for example, the amount of sucrose fatty acid ester and/or casein or a salt thereof can be appropriately adjusted to cope with the viscosity.

### <Examination of Cacao Fat Content>

### [Production of Frozen Dessert Product]

Various kinds of frozen dessert products were produced by mixing and freezing the components described in Table 1. Components of an emulsifier are as shown in Table 2. The term “total cocoa fat content” in the table means the amount of cocoa butter contained in a chocolate base.

TABLE 1

| | Example | Example | Example | Example | Example | Example |
|---|---|---|---|---|---|---|
| | A1 | A2 | A3 | A4 | A5 | A6 |
| Total cacao | 13% | 15% | 18% | 20% | 22% | 24% |
| fat content | | | | | | |
| Chocolate | 42% | 44% | 47% | 49% | 51% | 53% |
| base | | | | | | |
| Fresh cream | 10% | | | | | |
| Emulsifier | 0.7% | | | | | |
| Water | 47.3% | 45.3 | 42.3 | 40.3% | 38.3% | 36.3% |

TABLE 2
Emulsifier

| | |
|---|---|
| Sucrose fatty acid ester | 0.2% |
| (HLB: 11~13) | |
| Casein sodium | 0.2% |
| Other emulsifiers | 0.3% |
| Total | 0.7% |

Other emulsifiers: polyglyceryl fatty acid ester and egg-yolk oil

### [Evaluation of Frozen Dessert Product]

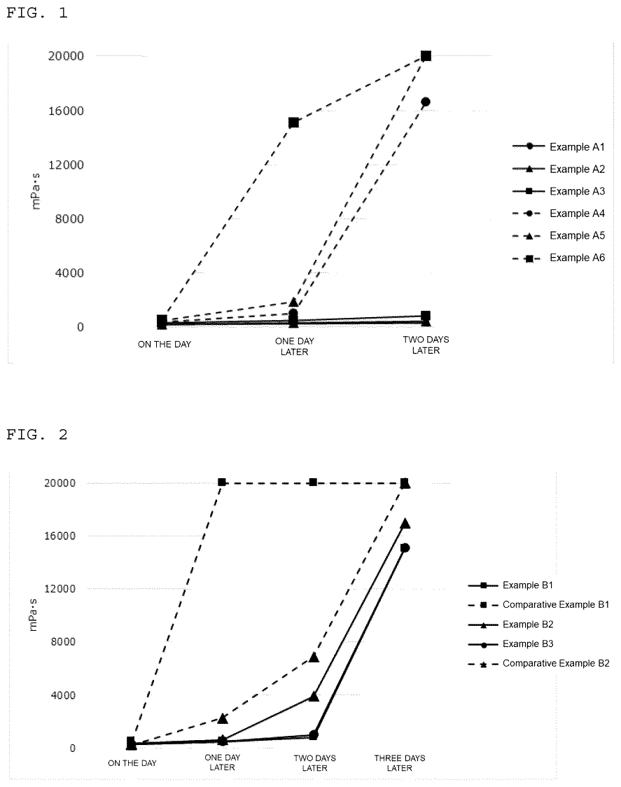

The viscosity of each of the frozen dessert products of Examples A1 to A6 was measured according to the measurement method and measurement conditions described above. The results are shown in FIG. 1. As a result of using the sucrose fatty acid ester and casein sodium, a thickening suppression effect was observed as compared with a case where the fatty acid ester and casein sodium were not used. In particular, a high thickening suppression effect was observed when the cacao fat content was 18% by mass or less.

### <Examination 1 of Emulsifier (Type)>

### [Production of Frozen Dessert Product]

A frozen dessert product having a total cacao fat content of 18% by mass was produced in a similar manner to Example A3 except that the emulsifier in Example A3 was changed to an emulsifier shown in Table 3.

TABLE 3

| | Exam- | Comparative | Comparative | Exam- | Exam- |
|---|---|---|---|---|---|
| | ple B1 | Example B1 | Example B2 | ple B3 | ple B2 |
| Sucrose fatty | 0.2% | — | 0.28% | 0.28% | 0.233% |
| acid ester | | | | | |
| (HLB: 11~13) | | | | | |
| Casein sodium | 0.2% | 0.28% | — | 0.28% | 0.233% |
| Egg-yolk oil | 0.2% | 0.28% | 0.28% | — | 0.233% |
| Polyglyceryl | 0.1% | 0.14% | 0.14% | 0.14% | — |
| fatty acid | | | | | |
| ester | | | | | |
| Total | 0.7% | 0.7% | 0.7% | 0.7% | 0.7% |

### [Evaluation of Frozen Dessert Product]

The viscosity of each of the frozen dessert products of Examples B1 to B3 and Comparative Examples B1 and B2 was measured according to the measurement method and measurement conditions described above. The results are shown in FIG. 2. From this result, it can be understood that the sucrose fatty acid ester most contributes to the thickening suppression effect, and next, the casein sodium contributes to the thickening suppression effect.

### <Examination 1 of Emulsifier (Amount)>

### [Production of Frozen Dessert Product]

A frozen dessert product having a total cacao fat content of 18% by mass was produced in a similar manner to Example A3 except that the emulsifier in Example A3 was changed to an emulsifier shown in Table 4 and the amount of water was changed such that the total amount of the frozen dessert product was 100% by mass. The term “proportion of casein sodium” in the table means the proportion of casein sodium based on the total mass of sucrose fatty acid ester and casein sodium.

TABLE 4

| | Exam- | Exam- | Exam- | Exam- | Comparative |
|---|---|---|---|---|---|
| | ple C1 | ple C2 | ple C3 | ple C4 | Example C1 |
| Sucrose fatty | 0.43% | 0.32% | 0.21% | 0.1% | 0% |
| acid ester | | | | | |
| (HLB: 11~13) | | | | | |
| Casein sodium | 0.21% | 0.32% | 0.43% | 0.54% | 0.64% |
| Total | 0.64% | 0.64% | 0.64% | 0.64% | 0.64% |
| Proportion of | 33% | 50% | 67% | 84% | 100% |
| casein sodium | | | | | |

### [Evaluation of Frozen Dessert Product]

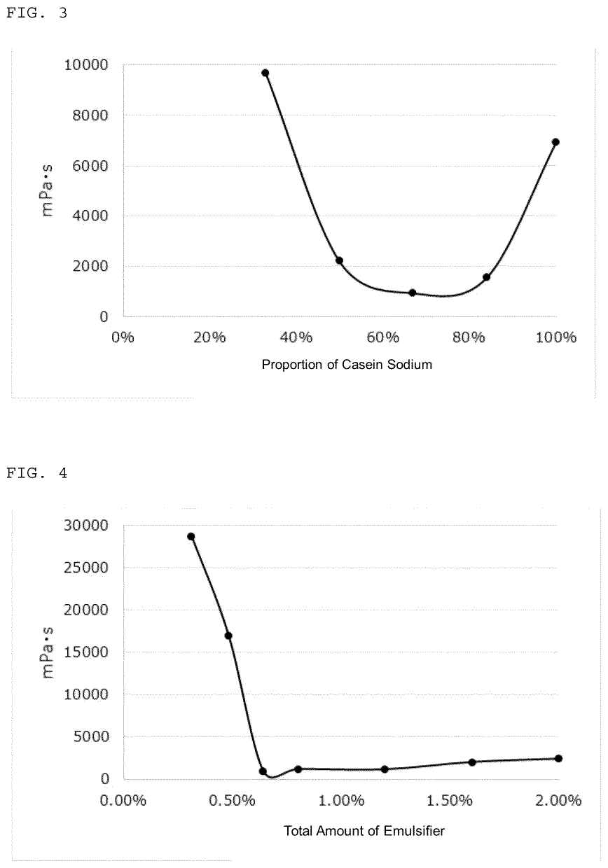

The viscosity of each of the frozen dessert products of Examples C1 to C4 and Comparative Example C1 was measured according to the measurement method and measurement conditions described above. The results two days later are shown in FIG. 3. When the proportion of casein sodium was from 50 to 84% by mass, a higher thickening suppression effect was observed.

From the results of FIG. 2, it was considered that the sucrose fatty acid ester most contributes to the thickening suppression effect. However, it doesn't mean that a large amount of sucrose fatty acid ester is merely used, and the results showed that the balance with casein sodium is important.

### <Examination 2 of Emulsifier (Amount)>

### [Production of Frozen Dessert Product]

A frozen dessert product having a total cacao fat content of 18% by mass was produced in a similar manner to Example C3 except that the total amount of the emulsifier (proportion of casein sodium: 67% by mass) in Example C3 was changed as shown in Table 5, and the amount of water was changed such that the total amount of the frozen dessert product was 100% by mass. The term “total amount of emulsifier” in the table means the total proportion of sucrose fatty acid ester and casein sodium based on the mass of the frozen dessert product.

TABLE 5

| | Example | Example | Example | Example | Example | Example | Example |
|---|---|---|---|---|---|---|---|
| | D1 | D2 | D3 | D4 | D5 | D6 | D7 |
| Total | 0.31% | 0.48% | 0.64% | 0.8% | 1.2% | 1.6% | 2% |
| Amount of | | | | | | | |
| Emulsifier | | | | | | | |

### [Evaluation of Frozen Dessert Product]

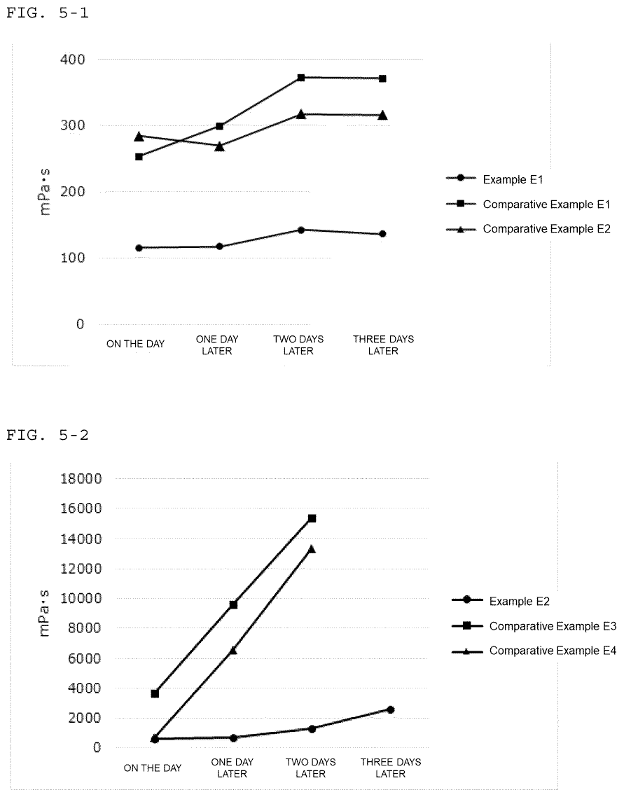

The viscosity of each of the frozen dessert products of Examples D1 to D7 was measured according to the measurement method and measurement conditions described above. The results two days later are shown in FIG. 4. When the total amount of the emulsifier was 0.64% by mass or more, a higher thickening suppression effect was observed.

### <Examination 2 of Emulsifier (Type)>

### [Production of Frozen Dessert Product]

The components described in Table 6 were mixed and frozen to produce various kinds of frozen dessert products. The term “total cocoa fat content” in the table means the amount of cocoa butter contained in a chocolate base.

TABLE 6

| | Example | Comparative | Comparative | Example | Comparative | Comparative |
|---|---|---|---|---|---|---|
| | E1 | Example E1 | Example E2 | E2 | Example E3 | Example E4 |
| Total cacao | 10% | 10% | 10% | 18% | 18% | 18% |
| fat content | | | | | | |
| Chocolate | — | — | — | 47% | 47% | 47% |
| base 1 | | | | | | |
| Chocolate | 42.4% | 42.4% | 42.4% | — | — | — |
| base 2 | | | | | | |
| Dairy product | 3.7% | 3.7% | 3.7% | 10% | 10% | 10% |
| Sucrose fatty | 0.26% | — | — | 0.26% | — | — |
| acid ester | | | | | | |
| (HLB: 11~13) | | | | | | |
| Casein sodium | 0.54% | — | — | 0.54% | — | — |
| Metaphosphate | — | 0.25% | 0.25% | — | 0.25% | 0.25% |
| Sorbitan | — | 0.4% | 0.05% | — | 0.4% | 0.05% |
| fatty acid | | | | | | |
| Ester (HLB: | | | | | | |
| 5.1) | | | | | | |
| Sucrose fatty | — | 0.3% | 0.3% | — | 0.3% | 0.3% |
| acid ester | | | | | | |
| (HLB: 15) | | | | | | |
| Water | 53.1% | 52.95% | 53.3% | 42.2% | 42.05% | 42.4% |

### [Evaluation of Frozen Dessert Product]

The viscosity of the frozen dessert products of Examples E1 and E2 and Comparative Examples E1 to E4 was measured according to the measurement method and measurement conditions described above. The results of Example E1 and Comparative Examples E1 and E2 are shown in FIG. 5-1. The results of Example E2 and Comparative Examples E3 and E4 are shown in FIG. 5-2. The viscosity of each of the frozen dessert products of Comparative Examples E3 and E4 was significantly increased as compared with Example E2. Three days later, the viscosity was too high to be measured.

Four sensory evaluation panelists tasted the frozen dessert products of Example E2 and Comparative Examples E3 and E4 taken out from a freezer at −18° C., and evaluated the chocolate flavor and melting in the mouth texture. Evaluation criteria for each evaluation item are as follows, and an average score is shown as an evaluation result in Table 7.

### [Chocolate Flavor]

5 scores: very good
4 scores: good
3 scores: neither
2 scores: poor
1 score: very poor

### [Melting in the Mouth Texture]

5 scores: very good
4 scores: good
3 scores: neither
2 scores: poor
1 score: very poor

TABLE 7

| | | Comparative | Comparative |
|---|---|---|---|
| | Example E2 | Example E3 | Example E4 |
| Chocolate | 5 scores | 3 scores | 2 scores |
| flavor | | | |
| Melting in the | 5 scores | 3 scores | 2 scores |
| mouth texture | | | |

### <Examination 3 of Emulsifier (Type)>

### [Production of Frozen Dessert Product]

The components described in Table 8 were mixed and frozen to produce various kinds of frozen dessert products. The term “cacao fat content” in the table means the amount of cocoa butter contained in a chocolate base.

TABLE 8

| | Example F1 | Example F2 |
|---|---|---|
| Cacao fat content | 13% | 13% |
| Chocolate base | 47% | 47% |
| Fresh cream | 10% | 10% |
| Mono-glyceride of fatty acid | 0.15% | — |
| Sucrose fatty acid ester | 0.15% | 0.2% |
| (HLB: 11~13) | | |
| Other emulsifiers | 0.3% | 0.3% |
| Casein sodium | 0.15% | 0.2% |
| Water | 42.3% | 42.3% |

### [Evaluation of Frozen Dessert Product]

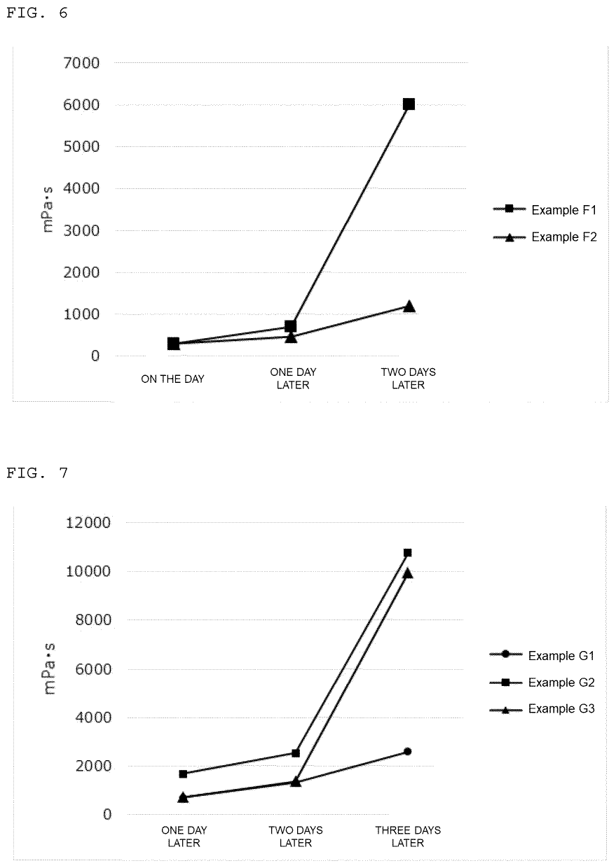

The viscosity of the frozen dessert products of Examples F1 and F2 was measured according to the measurement method and measurement conditions described above. The results are shown in FIG. 6. In the case of containing no emulsifier: mono-glyceride of fatty acid, the thickening suppression effect was further improved.

### <Examination 4 of Emulsifier (Type)>

### [Production of Frozen Dessert Product]

The components described in Table 9 were mixed and frozen to produce various kinds of frozen dessert products. The term “total cocoa fat content” in the table means the amount of cocoa butter contained in a chocolate base.

TABLE 9

| | Example G1 | Example G2 | Example G3 |
|---|---|---|---|
| Total cacao fat content | 18% | 18% | 18% |
| Chocolate base | 47% | 47% | 47% |
| Fresh cream | 10% | 10% | 10% |
| Sucrose fatty acid ester | 0.26% | — | — |
| (HLB: 11~13) | | | |
| Sucrose fatty acid ester | — | 0.26% | — |
| (HLB: 1) | | | |
| Sucrose fatty acid ester | — | — | 0.26% |
| (HLB: 15) | | | |
| Casein sodium | 0.54% | 0.54% | 0.54% |
| Water | 42.2% | 42.2% | 42.2% |

### [Evaluation of Frozen Dessert Product]

The viscosity of each of the frozen dessert products of Examples G1 to G3 was measured according to the measurement method and measurement conditions described above. The results are shown in FIG. 7. The use of a sucrose fatty acid ester having an HLB of 11 to 13 enabled the thickening suppression effect to be further improved.

1. A frozen dessert product comprising:
a raw material cacao containing cocoa butter;
a sucrose fatty acid ester; and
casein or a salt thereof.

2. The frozen dessert product according to claim 1, wherein
an amount of the casein or a salt thereof is from 50 to 84% by mass based on a total mass of the sucrose fatty acid ester and the casein or a salt thereof.

3. The frozen dessert product according to claim 1, wherein
a total amount of the sucrose fatty acid ester and the casein or a salt thereof is 0.64% by mass or more based on a mass of the frozen dessert product.

4. The frozen dessert product according to claim 1, wherein
an amount of the cocoa butter is from 3 to 22% by mass based on a mass of the frozen dessert product.

5. The frozen dessert product according to claim 1, wherein
the sucrose fatty acid ester has a hydrophilic-lipophilic balance of 1 to 15.

6. A method for producing a frozen dessert product, comprising mixing
a raw material cacao containing cocoa butter,
a sucrose fatty acid ester, and
casein or a salt thereof.

7. The method according to claim 6, wherein
an amount of the casein or a salt thereof is from 50 to 84% by mass based on a total mass of the sucrose fatty acid ester and the casein or a salt thereof.

8. The method according to claim 6, wherein
a total amount of the sucrose fatty acid ester and the casein or a salt thereof is 0.64% by mass or more based on a mass of the frozen dessert product.

9. The method according to claim 6, wherein
an amount of the cocoa butter is from 3 to 22% by mass based on a mass of the frozen dessert product.

10. The method according to claim 6, wherein
the sucrose fatty acid ester has a hydrophilic-lipophilic balance of 1 to 15.
